(19) United States
(12) Patent Application Publication
(10) Pub. No.: US 2002/0162854 A1
(43) Pub. Date: Nov. 7, 2002

(54) Gel and paste container possessing opposing dual heads

(76) Inventors: Harrison M. Slutsky, Canton, MA (US); David S. Slutsky, Canton, MA (US)

Correspondence Address: LAMBERT & ASSOCIATES, P.L.L.C., 92 STATE STREET, BOSTON, MA, 02109-2004, US

(21) Appl. No.: 09/847,137

(22) Filed: May 2, 2001

(51) Int. Cl. G01F 11/06; B65D 35/00; B65D 37/00

(52) U.S. Cl. 222/92; 222/330; 222/481; 222/482; 222/107

(57) ABSTRACT

A gel and paste container possessing opposing dual heads which allows for compete expulsion of the contents of the container, possesses no crimped end and shortens the maximum distance any particle of paste or gel must travel. The container is designed to be symmetric about a latitudinal axis and thus can stand freely on either end.

### FIELD OF THE INVENTION

The present invention relates generally to the field of fluid containment and dispensing containers and specifically to toothpaste dispensers.

### BACKGROUND OF THE INVENTION

U.S. Pat. No. 5,833,119 discloses a tubular container having one end closed by an end member provided with a discharge opening receiving a cap and the other end being closed by a flattened second end. The container is progressively flattened in order to remove the contents. In this configuration, the container, inevitably must be rolled up since the fluid or gel will tend to build up at the closed end and thus the distance the fluid must travel to be expelled must be abbreviated. Such rolling of the container can cause cracking and thus leaking and loss of fluid not to mention spillage on user and cabinet or counter.

U.S. Pat. No. 5,590,818 discloses a multisegmented nozzle for dispensing viscous materials, particularly for dispensing differently colored toothpaste into toothpaste tubes so as to produce toothpaste of striped appearance when dispensed from the tube. Although it has multiple openings, this invention does not address the problems remedied by the instant invention.

U.S. Pat. No. 6,193,114 B1 discloses a hygienic toothpaste dispenser comprising a main body member having a plurality of spouts from which an individual can dispense his or her own personally assigned, permanently marked tubular spout. Once again, although this invention possesses multiple openings, it does not address the problems remedied by the instant invention, since it is designed to be attached to the prior art conventional, one sided tube.

U.S. Pat. No. 5,813,572 discloses a dispenser particularly useful for dispensing toothpaste including a tubular body closed at one end and having an opening for receiving the neck portion of a toothpaste tube extending therefrom, the dispenser includes an arrangement for squeezing the contents of the tube out the discharge opening including a piston movable in an axial direction of the tubular body. Although this invention serves to remove toothpaste from a tube, it doesn't account for the toothpaste that will be lost upon folding and subsequent cracking of the tube.

U.S. Pat. No. 5,553,747 discloses a tubular toothpaste container having different toothpaste materials disposed within multiple internal segments of the container. Although this tube contains multiple internal segments, these segments are designed to dispense toothpaste from an individual opening and thus, this invention does not address the problems rectified by the instant invention.

U.S. Pat. No. 4,437,584 discloses a toothpaste dispenser comprising a container having a neck through which a tube connected to a plunger extends. Due to the constraints of reciprocating systems, the high viscosity of toothpaste, as needed for cleansing purposes, and the configuration of the container, the piston can never completely displace the total quantity of toothpaste contained in the chamber and tube.

No toothpaste container exists in prior that completely expels the full contents of the container, due to either the constraints of the system used or container construction.

### SUMMARY OF THE INVENTION

The present invention overcomes the above-described shortcomings in providing a container, which due to its construction can displace the complete contents of toothpaste or gel contained within. The present system is composed of a body and two end sections with openings for removal of pastes or gels. These opens are located on opposing sides of a cylindrically shaped container.

It is therefore an object of the present invention to provide a container, which allows for the complete displacement of the contents of the container, whether the substance be a gel or a paste, such as toothpaste.

It is a further object of this invention to provide a tube, which is symmetric about an axis bisecting the tube and thus can stand on end when either side of the tube is utilized.

Other objectives, features and advantages of the invention will be apparent from the following detailed disclosure, taken in conjunction with the accompanying sheets of drawings, wherein like reference numerals refer to like parts.

### BRIEF DESCRIPTION OF THE DRAWING

FIG. 1 is a plan view of the container showing the two dispensing projection and the cylindrical midsection.

FIG. 2 is a plan view of the container showing the two dispensing projection and the rectangular midsection.

FIG. 3 is a plan view of the container showing the two dispensing projections with flip top caps and the rectangular midsection.

### DETAILED DESCRIPTION OF THE PREFFERED EMBODIMENT

As can be seen by the numerous inventions disclosed above, the problem of trying to completely remove pastes and other gels from a container is an ongoing one. To settle the this problem of getting the maximum possible amount of paste or gel out of the tube, elimination of the crimped end, where paste or gel has a tendency to build up is essential. Tubes crack and break when rolled up.

As can be seen in pump type systems, paste or gel is left in the tube and pumping chamber, thus these are not positive displacement systems. The container is progressively flattened in order to remove the contents. In this configuration, the container, inevitably must be rolled up since the fluid or gel will tend to build up at the closed end and thus the distance the fluid must travel to be expelled must be abbreviated. Where thicker, less flexible polymer materials are utilized, rolling cannot be accomplished and thus a large quantity of fluid cannot be removed from the container. The present invention expels the complete contents of paste or gel also because the distance to travel to an opening is cut approximately in half.

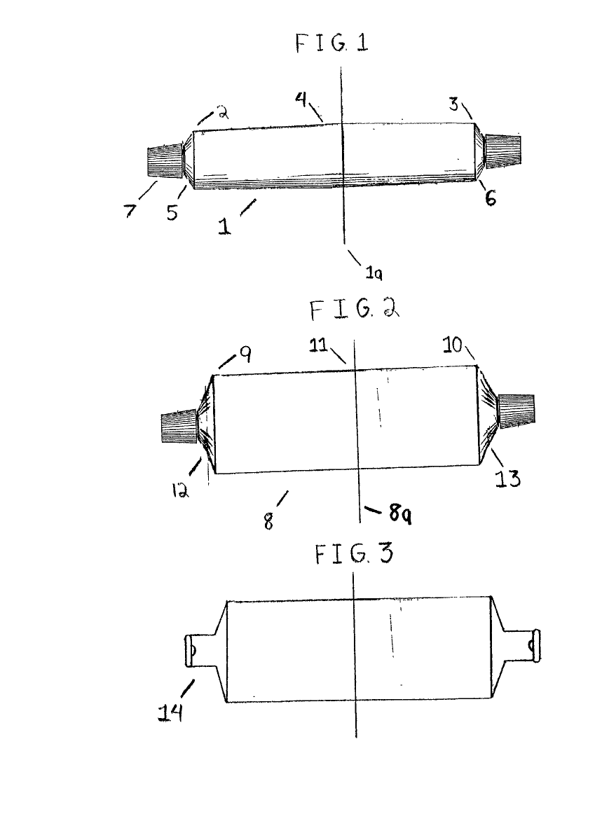

As illustrated in FIGS. 1-3, in one embodiment, the instant invention encompasses a tubular container 1 for dispensing gels and pastes. The container 1 comprises a first end 2 and a second end 3 and a tubular body 4. Affixed to an opening on the first end 2 of the container is a first projection 5 for dispensing pastes or gels. Affixed to an opening on the second end 3 of the container is a second projection 6 for dispensing pastes or gels.

The projections may possess a screw on cap closing system 7, as seen in the art. Both projections will thus possess external threads, which are designed to mate with and be covered by internally threaded screw on caps, as seen in the art. As an alternative embodiment, the two dispensing projections may be equipped with a flip top cap system, rather than the threaded cap system described above. The container 1 is symmetric about a latitudinal axis 1a.

In another embodiment, the instant invention encompasses a rectangular container 8 for dispensing gels and pastes. The container 8 comprises a first end 9 and a second end 10 and a rectangular body 11. Affixed to an opening on the first end 9 of the container is a first projection 12 for dispensing pastes or gels. Affixed to an opening on the second end 10 of the container is a second projection 13 for dispensing pastes or gels.

Again, the projections may possess a screw on cap closing system, as seen in the art. Both projections will thus possess external threads, which are designed to mate with and be covered by screw on caps, as used in the art. Both projections possess external threads, which are designed to mate with and be covered by internally threaded screw on caps, as seen in the art. As an alternative embodiment, the two dispensing projections may be equipped with a flip top cap system, rather than the threaded cap system described above. The container 8 is symmetric about a latitudinal axis 8a. FIG. 3 illustrates a rectangular embodiment with the flip top cap 14.

The novel design of the container, in all embodiments allows for the complete displacement of the contents of the container, due to the lack of a crimped end portion which tends to trap materials. Therefore, the present invention does not require folding, and thus no cracking and subsequent leakage will occur. Also, the distance the portion of paste located furthest from either projection must travel to be expelled from a projection is cut in half with respect to prior art single projection containers, wherein the paste furthest away from the projection had to travel the full length of the tube to be expelled.

Another important feature of the present invention is the space saving properties inherent with a symmetric tube, possessing the ability to stand on both ends. Prior art tubes, which contain crimped ends, obviously cannot stand on the crimped end. Although prior art tubes often possess the ability to stand on the projection end upon initial use, often the imbalance due to tube shape or the resulting imbalance occurring when rolling the crimped end of the tube usually results in the tube falling over. Thus, the symmetrical qualities of the present invention allow near perfect balance.

The invention is not limited to toothpastes and gels and thus can be utilized to contain and dispense all kinds of pastes and gels including hair products, facial products and caulking pastes and not limited by the usages mentioned herein.

The above embodiments considered, it will be observed that numerous different configurations and alternatives may be achieved with out straying from the scope of the original invention. With this in mind, it is stated that no limitation with respect to the specific apparatus illustrated herein is intended or should be inferred. It is, of course, intended to cover by the appended claims all such modifications as are covered by the scope of the claims.

I claim:

1. A container for pastes and gels comprising a body and two end portions, both end portions possessing projections from which a substance retained in said contained may be discharged.

2. The container for pastes and gels of claim 1 wherein no crimped end portion is included.

3. The container for pastes and gels of claim 2 wherein said container stands on end when either end is employed.

4. The container for pastes and gels of claim 3 wherein the contents of said container are completely emptied upon conclusion of usage.

5. The container for pastes and gels of claim 4 wherein said container is symmetric about a latitudinal axis.

6. The container for pastes and gels of claim 5 wherein said container does not require folding to expel the contents of said tube.

7. The container for pastes and gels of claim 6 wherein a portion of paste located furthest from said projection must travel one half the normal distance to be expelled from said projection.

8. The container for pastes and gels of claim 7 wherein said body has a tubular shape.

9. The container for pastes and gels of claim 8 wherein said projections possess a screw on cap closing system.

10. The container for pastes and gels of claim 8 wherein said projections are covered by flip top caps.

11. The container for pastes and gels of claim 7 wherein said body has a rectangular shape.

12. The container for pastes and gels of claim 11 wherein said projections possess a screw on cap closing system.

13. The container for pastes and gels of claim 111 wherein said projections are covered by flip top caps.
